(19) United States
(12) Patent Application Publication
(10) Pub. No.: US 2026/0251997 A1
(43) Pub. Date: Aug. 27, 2026

(54) IMAGE FORMING APPARATUS AND SETTING METHOD EACH OF WHICH ALLOWS PLURALITY OF ATTACHMENT PORTIONS TO BE PREVENTED FROM BEING UNEVEN IN FREQUENCY OF USE

(71) Applicant: KYOCERA Document Solutions Inc., Osaka (JP)

(72) Inventor: Hiroyuki Yamaguchi, Osaka (JP)

(21) Appl. No.: 19/532,999

(22) Filed: Feb. 6, 2026

(30) Foreign Application Priority Data
Feb. 27, 2025 (JP) 2025-030106

(51) Int. Cl. G03G 15/08; G03G 15/00; G03G 21/16

(52) U.S. Cl. CPC G03G 15/0865; G03G 15/0856; G03G 15/556; G03G 21/1633

(57) ABSTRACT

An image forming apparatus includes a supply processing portion, a first sensing processing portion, and a first setting processing portion. The supply processing portion supplies developer to an image forming portion from a developer storing portion attached to a specific attachment portion. The first sensing processing portion senses state transition from a first state in which an amount of the developer remaining in the developer storing portion attached to the specific attachment portion exceeds a first threshold to a second state in which the amount is less than or equal to the first threshold. The first setting processing portion sets any of a plurality of attachment portions as the specific attachment portion on the basis of a setting status of the specific attachment portion up to time of sensing of the state transition in a case where the state transition is sensed.

### INCORPORATION BY REFERENCE

This application is based upon and claims the benefit of priority from the corresponding Japanese Patent Application No. 2025-030106 filed on February 27, 2025, the entire contents of which are incorporated herein by reference.

### BACKGROUND

This disclosure relates to an image forming apparatus and a setting method.

An image forming apparatus including an image forming portion that forms an image using developer such as toner and ink has been known. In addition, the image forming apparatus including a plurality of attachment portions to which a plurality of developer storing portions that stores the developers of the same color is attached has been known.

In the image forming apparatus including the plurality of attachment portions, the developer is supplied to the image forming portion from the developer storing portion attached to a specific attachment portion set in advance among the plurality of attachment portions.

### SUMMARY

An image forming apparatus according to an aspect of this disclosure includes an image forming portion, a plurality of attachment portions, a supply processing portion, a first sensing processing portion, and a first setting processing portion. The image forming portion forms an image using developer. A plurality of developer storing portions is attached to a plurality of the attachment portions. The plurality of developer storing portions stores the developers of a same color. The supply processing portion supplies the developer to the image forming portion from the developer storing portion attached to a specific attachment portion that is any of a plurality of the attachment portions set in advance. The first sensing processing portion senses state transition from a first state in which an amount of the developer remaining in the developer storing portion attached to the specific attachment portion exceeds a first threshold defined in advance to a second state in which the amount of the developer remaining in the developer storing portion is less than or equal to the first threshold. The first setting processing portion sets any of a plurality of the attachment portions as the specific attachment portion on the basis of a setting status of the specific attachment portion up to time of sensing of the state transition in a case where the state transition is sensed by the first sensing processing portion.

A setting method according to another aspect of this disclosure is executed by an image forming apparatus including an image forming portion that forms an image using developer, and a plurality of attachment portions to which a plurality of developer storing portions that stores the developers of a same color is attached. The setting method includes a supply step, a sensing step, and a setting step. In the supply step, the developer is supplied to the image forming portion from the developer storing portion attached to a specific attachment portion that is any of a plurality of the attachment portions set in advance. In the sensing step, state transition from a first state in which an amount of the developer remaining in the developer storing portion attached to the specific attachment portion exceeds a first threshold defined in advance to a second state in which the amount of the developer remaining in the developer storing portion is less than or equal to the first threshold is sensed. In the setting step, any of a plurality of the attachment portions is set as the specific attachment portion on the basis of a setting status of the specific attachment portion up to time of sensing of the state transition in a case where the state transition is sensed through the sensing step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to an embodiment.

FIG. 2 is a configuration diagram of a toner supply portion in the image forming apparatus according to the embodiment.

FIG. 3 is a configuration diagram of a cover member in the image forming apparatus according to the embodiment.

FIG. 4 is a block diagram showing a configuration of a control device in the image forming apparatus according to the embodiment.

FIG. 5 is a flowchart showing an example of a procedure of a specific attachment portion setting process that is executed by the image forming apparatus according to the embodiment.

FIG. 6 is a flowchart showing an example of a procedure of an interruption process that is executed by the image forming apparatus according to the embodiment.

### DETAILED DESCRIPTION

Hereinafter, an embodiment of this disclosure will be described with reference to the drawings. It is noted that the following embodiment is a specific example of this disclosure and does not limit the technical scope of this disclosure.

### Configuration of Image Forming Apparatus 10

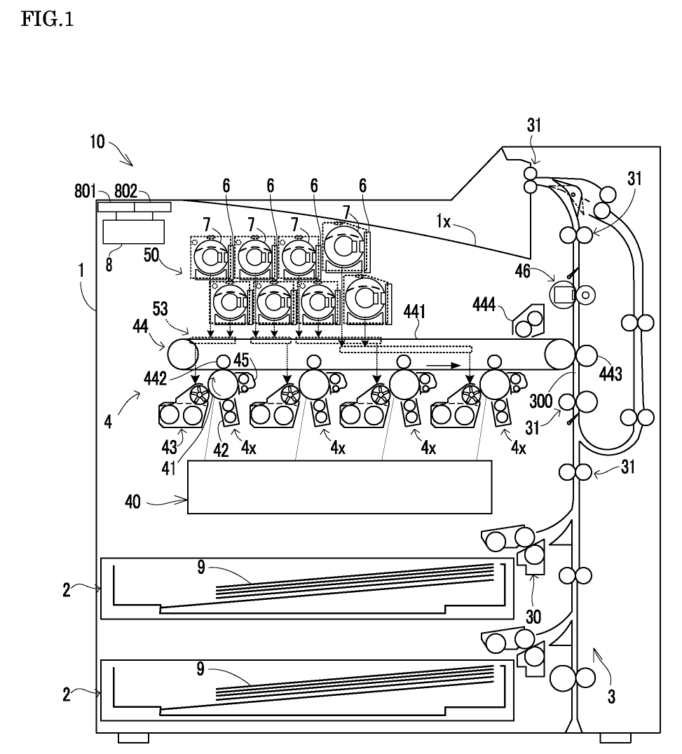

An image forming apparatus 10 according to this embodiment is capable of forming an image on a sheet 9 (see FIG. 1). The image forming apparatus 10 shown in FIG. 1 is a printer. It is noted that the image forming apparatus 10 may be a copying machine, a facsimile apparatus, a multifunction peripheral, or the like.

As shown in FIG. 1, the image forming apparatus 10 includes a main housing 1, sheet storing portions 2, a conveying device 3, a printing device 4, a toner supply portion 50, a control portion 8, an operation device 801, and a display device 802. The main housing 1 is a housing that stores the conveying device 3, the printing device 4, the toner supply portion 50, and the control portion 8.

The main housing 1 includes a conveyance path 300. The conveyance path 300 is a path of the sheet 9. The conveying device 3 includes a sheet feeding mechanism 30 and a plurality of conveying roller pairs 31. The sheet feeding mechanism 30 feeds the sheets 9 stored in the sheet storing portions 2 to the conveyance path 300 one by one. The plurality of conveying roller pairs 31 conveys the sheet 9 along the conveyance path 300. One of the plurality of conveying roller pairs 31 discharges the sheet 9 on which an image is formed by the printing device 4 onto a discharge tray 1x (see FIG. 1) from the conveyance path 300.

The printing device 4 shown in FIG. 1 forms an image by electrophotography on the sheet 9 conveyed along the conveyance path 300. It is noted that the image forming apparatus 10 is not limited to electrophotography and may be an image forming apparatus which uses an inkjet method as another embodiment.

The printing device 4 forms an image using toner (an example of developer according to this disclosure). The printing device 4 is an example of an image forming portion according to this disclosure.

As shown in FIG. 1, the printing device 4 includes an exposure device 40, one or more image forming units 4x, a transfer device 44, and a fixing device 46. The printing device 4 shown in FIG. 1 is a tandem-type color printing device. In this case, the printing device 4 includes the plurality of image forming units 4x corresponding to a plurality of developed colors. It is noted that the image forming apparatus 10 is not limited to a color printing device and may be a monochrome printing device as another embodiment.

The printing device 4 shown in FIG. 1 includes the four image forming units 4x corresponding to the developed colors of yellow (Y), magenta (M), cyan (C), and black (Bk).

Each of the image forming units 4x includes a photoconductor 41, a charging device 42, a developing device 43, and a first cleaning device 45. The photoconductor 41 rotates and the charging device 42 charges the surface of the photoconductor 41.

The exposure device 40 scans the charged surface of the photoconductor 41 with laser light to draw an electrostatic latent image on the surface of the photoconductor 41. The developing device 43 supplies toner to the surface of the photoconductor 41 to develop the electrostatic latent image into a toner image.

The transfer device 44 transfers the toner image on the surface of the photoconductor 41 to the sheet 9 conveyed along the conveyance path 300. In the tandem-type printing device 4, the transfer device 44 includes an intermediate transfer belt 441, a plurality of primary transfer devices 442, a secondary transfer device 443, and a second cleaning device 444. The plurality of primary transfer devices 442 is provided in association with the plurality of image forming units 4x.

The intermediate transfer belt 441 partially rotates along the plurality of image forming units 4x. The plurality of primary transfer devices 442 transfers the toner images on the surfaces of the photoconductors 41 of the plurality of image forming units 4x to the surface of the intermediate transfer belt 441. This forms, on the surface of the intermediate transfer belt 441, a color toner image in which the toner images of the plurality of colors are combined.

The secondary transfer device 443 transfers the color toner image on the surface of the intermediate transfer belt 441 to the sheet 9. The fixing device 46 heats and pressurizes the color toner image on the sheet 9 to fix the color toner image onto the sheet 9. It is noted that the sheet 9 is a sheet-shaped image forming medium such as a paper sheet.

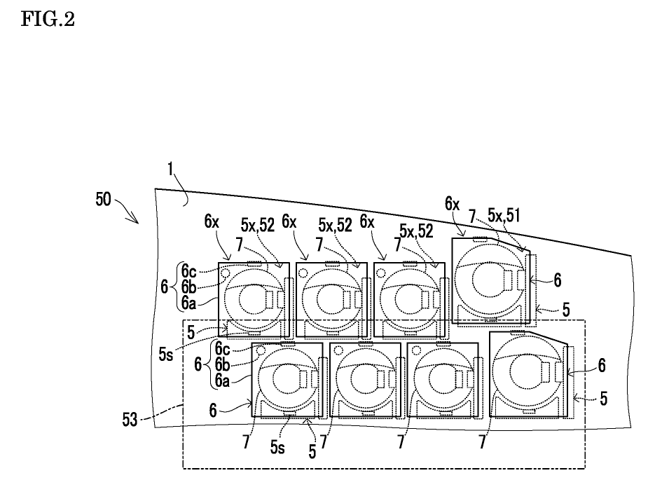

The toner supply portion 50 supplies toners to the developing devices 43 of the plurality of image forming units 4x in the printing device 4. The toner supply portion 50 includes a plurality of attachment portions 5 (see FIG. 2). Each of the attachment portions 5 is a portion to which a toner container 7 (see FIG. 2) is detachably attached.

The toner supply portion 50 supplies the toners in the plurality of toner containers 7 attached to the plurality of attachment portions 5 to the developing devices 43 of the plurality of image forming units 4x for the respective developed colors. Each of the toner containers 7 is an example of a developer storing portion that stores developer.

The operation device 801 is a device that receives an operation of a user. For example, the operation device 801 includes one or both of a touch panel and an operation button.

The display device 802 is capable of displaying various kinds of information. For example, the display device 802 is a panel display device such as a liquid-crystal display device.

The control portion 8 integrally controls the image forming apparatus 10.

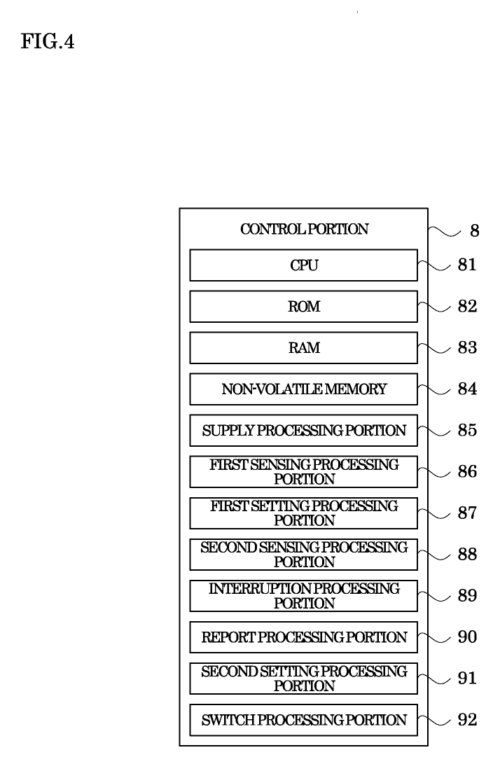

As shown in FIG. 4, the control portion 8 includes a CPU 81, a ROM 82, a RAM 83, and a non-volatile memory 84. The CPU 81 is a processor that executes various calculation processes. The ROM 82 is a non-volatile storage device in which information such as a control program or the like for causing the CPU 81 to execute various processes is stored in advance. The RAM 83 is a volatile or non-volatile storage device that is used as a temporary storage memory (work area) for the various processes which are executed by the CPU 81. The non-volatile memory 84 is a non-volatile storage device. The CPU 81 integrally controls the image forming apparatus 10 by executing various control programs stored in the ROM 82 in advance.

It is noted that the control portion 8 may be a control portion provided separately from a main control portion which integrally controls the image forming apparatus 10. In addition, the control portion 8 may be composed of an electronic circuit such as an integrated circuit (ASIC).

In this embodiment, the toner supply portion 50 includes the pair of attachment portions 5 for each of the plurality of developed colors (see FIG. 2). The toner supply portion 50 includes the pair of attachment portions 5 for each of toners of the four colors of yellow, magenta, cyan, and black.

In other words, the toner supply portion 50 includes the two attachment portions 5 to which the two toner containers 7 that store toners of the same color are attached. This makes it possible to avoid the occurrence of downtime even while the toner container 7 is being replaced in the image forming apparatus 10.

The toner supply portion 50 includes four attachment portion sets 5x (see FIG. 2). The four respective attachment portion sets 5x correspond to toners of yellow, magenta, cyan, and black. Yellow, magenta, cyan, and black are respective examples of a developed color.

Each of the four attachment portion sets 5x includes the pair of attachment portions 5. The toner supply portion 50 thus includes the eight attachment portions 5. In each of the four attachment portion sets 5x, the two toner containers 7 of the same color are attached to the pair of attachment portions 5. It is noted that the following refers to one of the attachment portions 5 included in each of the four attachment portion sets 5x as a first attachment portion and refers to the other as a second attachment portion in some cases.

The four attachment portion sets 5x include one black attachment portion set 51 corresponding to black toner and three color attachment portion sets 52 corresponding to three color toners. The three color attachment portion sets 52 correspond to yellow, magenta, and cyan.

In the toner supply portion 50 shown in FIG. 2, the pair of toner containers 7 attached to the one black attachment portion set 51 is larger in toner storage capacity than each of the three pairs of toner containers 7 attached to the three color attachment portion sets 52.

As shown in FIG. 2, the toner supply portion 50 further includes a supply mechanism 53, eight lock mechanisms 6 corresponding to the eight attachment portions 5, and eight toner sensors 5s.

As described below, one of the pair of attachment portions 5 is selected as a specific attachment portion for each of the four attachment portion sets 5x. The following description refers to one of the pair of toner containers 7 attached to the specific attachment portion in each of the four attachment portion sets 5x as a specific container in some cases.

The supply mechanism 53 supplies toner to the corresponding developing device 43 from the specific container for each of the four attachment portion sets 5x. That is, in each of the four attachment portion sets 5x, the specific container serves as a supply source of toner by the supply mechanism 53.

The supply mechanism 53 includes supply portions corresponding to the four respective attachment portion sets 5x. Each of the supply portions includes a drive portion, a first individual supply path, a second individual supply path, a first common supply path, a second common supply path, and a conveyance member. The drive portion supplies the specific container with driving force. The specific container discharges the toner stored therein to the outside upon receiving the driving force supplied from the drive portion. The first individual supply path guides, down in the perpendicular direction, the toner discharged from the toner container 7 attached to the first attachment portion. The second individual supply path guides, down in the perpendicular direction, the toner discharged from the toner container 7 attached to the second attachment portion. The first common supply path guides, along the horizontal direction, the toners guided by the first individual supply path and the second individual supply path. The conveyance member conveys toner passing through the first individual supply path or the second individual supply path and dropping on the first common supply path to a discharge port leading to the second common supply path. The second common supply path extends down in the perpendicular direction to the developing device 43 from the discharge port in the first common supply path.

The eight lock mechanisms 6 are divided into four lock mechanism sets 6x corresponding to the four attachment portion sets 5x (see FIG. 2). The four lock mechanism sets 6x correspond to the one black attachment portion set 51 and the three color attachment portion sets 52. Each of the four lock mechanism sets 6x includes the pair of lock mechanisms 6 corresponding to the pair of attachment portions 5.

It is noted that the eight lock mechanisms 6 can also be considered the four pairs of lock mechanisms 6 corresponding to the four attachment portion sets 5x. Similarly, the eight toner sensors 5s can also be considered the four pairs of toner sensors 5s corresponding to the four attachment portion sets 5x.

The eight toner sensors 5s are used to determine the presence or absence of toners in the eight respective toner containers 7 attached to the eight attachment portions 5. For example, the respective toner sensors 5s are magnetic permeability sensors that each sense the amount of toner remaining in the toner container 7.

It is noted that the respective toner sensors 5s may be a plurality of photosensors which senses the storage levels of the toners in the respective toner containers 7. In addition, the respective toner sensors 5s may be load cells that each measure the weight of the toner container 7. In addition, the pair of toner sensors 5s corresponding to each of the attachment portion sets 5x may be a photosensor capable of sensing the presence or absence of toner dropping in the first individual supply path and a photosensor capable of sensing the presence or absence of toner dropping in the second individual supply path.

It is determined in the image forming apparatus 10 in which of an attachment state and a non-attachment state the respective attachment portions 5 are on the basis of results of sensing by the respective toner sensors 5s. In the attachment state, the toner containers 7 are attached. In the non-attachment state, the toner containers 7 are not attached.

That is, the respective toner sensors 5s also serve as attachment sensors that sense in which of the attachment state and the non-attachment state the respective attachment portions 5 are.

It is noted that the toner supply portion 50 may include the eight attachment sensors corresponding to the eight attachment portions 5 separately from the respective toner sensors 5s.

Each of the lock mechanisms 6 is a mechanism capable of changing the state between a lock state and a release state. The lock state of each of the lock mechanisms 6 is a state in which detachment from each of the attachment portions 5 corresponding to the respective toner containers 7 is made impossible. The release state of each of the lock mechanisms 6 is a state in which detachment from each of the attachment portions 5 corresponding to the respective toner containers 7 is made possible.

In this embodiment, each of the lock mechanisms 6 includes a container cover 6a, a cover sensor 6b, and a cover latch mechanism 6c.

The container cover 6a is capable of opening and closing an opening leading to one of the eight attachment portions 5 in the main housing 1.

The cover latch mechanism 6c is selectively switched between a state in which the container cover 6a is latched at a closed position and a state in which the container cover 6a is unlatched in accordance with a received lock control signal. For example, the cover latch mechanism 6c includes a solenoid or the like. The state of the solenoid is switched in accordance with the lock control signal.

The state in which the cover latch mechanism 6c latches the container cover 6a at the closed position is the lock state of the lock mechanism 6. The state in which the cover latch mechanism 6c unlatches the container cover 6a is the release state of the lock mechanism 6.

The cover sensor 6b senses in which of a cover closed state and a cover open state the container cover 6a is. The cover closed state is a state in which the container cover 6a is present at the closed position. The cover open state is a state in which the container cover 6a is not present at the closed position.

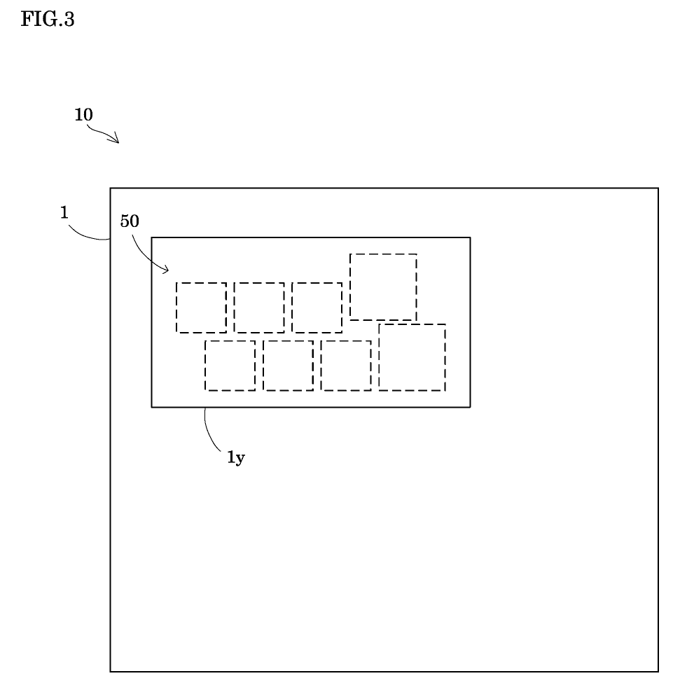

The main housing 1 includes a cover member 1y shown in FIG. 3. The cover member 1y is opened and closed when the toner container 7 is replaced. The cover member 1y forms a part of the outside surface of the main housing 1 when closed relative to the main housing 1. When the cover member 1y is opened relative to the main housing 1, the eight container covers 6a located inside the main housing 1 are exposed to the outside.

When the respective toner containers 7 are attached to and detached from the corresponding attachment portions 5, the corresponding container covers 6a are opened. For example, each of the cover sensors 6b is a contactless photosensor, a contact micro-switch, or the like.

Incidentally, when the pair of attachment portions 5 is uneven in frequency of use as the specific attachment portion, more toner adheres to the individual supply path of the first individual supply path and the second individual supply path that corresponds to the attachment portion 5 higher in frequency of use than the other individual supply path. This disadvantageously increases the frequency of maintenance of the apparatus.

In contrast, the image forming apparatus 10 according to the embodiment of this disclosure makes it possible to prevent the pair of attachment portions 5 from being uneven in frequency of use as described below.

### Functional Configuration of Control Portion 8

Next, the functional configuration of the control portion 8 will be described with reference to FIG. 4.

As shown in FIG. 4, the control portion 8 includes a supply processing portion 85, a first sensing processing portion 86, a first setting processing portion 87, a second sensing processing portion 88, an interruption processing portion 89, a report processing portion 90, a second setting processing portion 91, and a switch processing portion 92.

Specifically, the ROM 82 of the control portion 8 stores an operation control program in advance for causing the CPU 81 to function as each of the processing portions described above. The CPU 81 then functions as each of the processing portions described above by executing the operation control program stored in the ROM 82.

It is noted that the operation control program may be recorded in a computer-readable recording medium such as a CD, a DVD, and a flash memory. The operation control program may be read from the recording medium and stored in a non-volatile storage device provided in the image forming apparatus 10. In addition, some or all of the processing portions included in the control portion 8 may be composed of an electronic circuit. In addition, the operation control program may be a program for causing a plurality of processors to function as the respective processing portions included in the control portion 8.

It is noted that the following gives description using the black attachment portion set 51 of the four attachment portion sets 5x as an example. The following description also applies to the three respective color attachment portion sets 52.

The supply processing portion 85 supplies toner to the developing device 43 corresponding to the developed color of black (Bk) of the printing device 4 from the toner container 7 attached to the specific attachment portion that is either of the pair of attachment portions 5 included in the black attachment portion set 51 which is set in advance.

Here, in the image forming apparatus 10, specific attachment portion identifying information for identifying which of the pair of attachment portions 5 included in the black attachment portion set 51 is the specific attachment portion is stored in a specific storage region defined in advance in the non-volatile memory 84. For example, the specific attachment portion identifying information is information indicating either of the first attachment portion and the second attachment portion.

While an image formation process of forming an image using the printing device 4 is in execution, the supply processing portion 85 identifies the specific attachment portion using the specific attachment portion identifying information in a case where the amount of toner remaining in the developing device 43 corresponding to the developed color of black (Bk) is less than or equal to a third threshold defined in advance. The supply processing portion 85 then supplies toner to the developing device 43 corresponding to the developed color of black (Bk) from the toner container 7 attached to the specific attachment portion. It is noted that the supply processing portion 85 is capable of sensing the amount of toner remaining in the developing device 43 corresponding to the developed color of black (Bk) using an unillustrated toner remaining amount sensing sensor capable of sensing the amount of toner remaining in the developing device 43.

The first sensing processing portion 86 senses state transition from a first state in which the amount of toner remaining in the toner container 7 attached to the specific attachment portion exceeds a first threshold defined in advance to a second state in which the amount of toner remaining in the toner container 7 is less than or equal to the first threshold.

Here, the first threshold is zero. That is, the first state is a state in which the toner container 7 attached to the specific attachment portion is not empty. In addition, the second state is a state in which the toner container 7 attached to the specific attachment portion is empty.

While the image formation process is in execution, the first sensing processing portion 86 periodically senses the amount of toner remaining in the toner container 7 attached to the specific attachment portion using the toner sensor 5s corresponding to the specific attachment portion, thereby sensing the state transition.

It is noted that the first threshold may be a value which exceeds zero.

The first setting processing portion 87 sets either of the pair of attachment portions 5 included in the black attachment portion set 51 as the specific attachment portion on the basis of the setting status of the specific attachment portion up to the time of the sensing of the state transition in a case where the state transition is sensed by the first sensing processing portion 86.

Specifically, in a case where the state transition is sensed by the first sensing processing portion 86, the first setting processing portion 87 sets, as the specific attachment portion, the attachment portion 5 different from the attachment portion 5 set as the specific attachment portion when the specific attachment portion is set immediately before. That is, in a case where the state transition is sensed by the first sensing processing portion 86, the first setting processing portion 87 switches the specific attachment portion.

The specific attachment portion is changed by rewriting the specific attachment portion identifying information stored in the specific storage region of the non-volatile memory 84. Information indicating the setting status of the specific attachment portion from the time when the first setting processing portion 87 sets the specific attachment portion for the last time is hereby stored in the specific storage region.

The first setting processing portion 87 recognizes the attachment portion 5 set as the specific attachment portion when the specific attachment portion is set immediately before on the basis of the specific attachment portion identifying information stored in the specific storage region.

The second sensing processing portion 88 senses a third state in which the amount of toner remaining in the developing device 43 corresponding to the developed color of black (Bk) is less than or equal to a second threshold defined in advance. The second threshold is a value lower than the third threshold. The third state is a state in which it is not possible to continue the image formation process due to the lack of the black toner.

Specifically, the second sensing processing portion 88 senses the third state using the toner remaining amount sensing sensor corresponding to the developing device 43 corresponding to the developed color of black (Bk).

In a case where the third state is sensed by the second sensing processing portion 88, the interruption processing portion 89 interrupts the image formation process.

This makes it possible to prevent the quality of an image formed through the image formation process from decreasing due to the lack of the amount of toner remaining in the developing device 43 corresponding to the developed color of black (Bk).

Here, in a case where the image formation process is interrupted by the interruption processing portion 89, the control portion 8 changes the state of each of the lock mechanisms 6 included in the one lock mechanism set 6x corresponding to the one black attachment portion set 51 from the lock state to the release state. This allows a user to replace the toner containers 7 attached to the one black attachment portion set 51.

In addition, in a case where a closing operation on the cover member 1y (see FIG. 3) is sensed after the image formation process is interrupted, the control portion 8 changes the state of each of the lock mechanisms 6 included in the one lock mechanism set 6x corresponding to the one black attachment portion set 51 from the release state to the lock state. That is, in a case where the closing operation is sensed after the image formation process is interrupted, it is determined in the image forming apparatus 10 that an operation of replacing the toner container 7 comes to an end and the pair of toner containers 7 attached to the one black attachment portion set 51 is prohibited from being replaced. It is noted that the control portion 8 is capable of sensing the closing operation using an unillustrated opening and closing detecting sensor capable of sensing the open and closed states of the cover member 1y.

In a case where the toner container 7 is not attached to the specific attachment portion and the toner container 7 is attached to the attachment portion 5 different from the specific attachment portion when the closing operation is sensed after the image formation process is interrupted, the second setting processing portion 91 sets either of the attachment portions 5 to which the toner container 7 is attached as the specific attachment portion.

The switch processing portion 92 switches between enabling and disabling the function of the second setting processing portion 91 in response to an operation of a user.

For example, the switch processing portion 92 causes the display device 802 to display a function setting screen used to enable and disable the function of the second setting processing portion 91 in response to an operation of a user defined in advance on the operation device 801. The function setting screen receives an operation of a user that selects whether to enable or disable the function of the second setting processing portion 91. The switch processing portion 92 sets the function of the second setting processing portion 91 to be enabled or disabled in response to an operation of a user on the function setting screen.

In a case where the toner container 7 is not attached to the specific attachment portion, the toner container 7 is attached to the attachment portion 5 different from the specific attachment portion, and the function of the second setting processing portion 91 is disabled when the closing operation on the cover member 1y is sensed after the image formation process is interrupted, the report processing portion 90 reports that the toner container 7 is attached to the attachment portion 5 different from the specific attachment portion.

Specifically, the report processing portion 90 causes the display device 802 to display a second guidance screen including a message indicating that the toner container 7 is attached to the attachment portion 5 different from the specific attachment portion. It is noted that the report processing portion 90 may use sound to report that the toner container 7 is attached to the attachment portion 5 different from the specific attachment portion.

### Specific Attachment Portion Setting Process

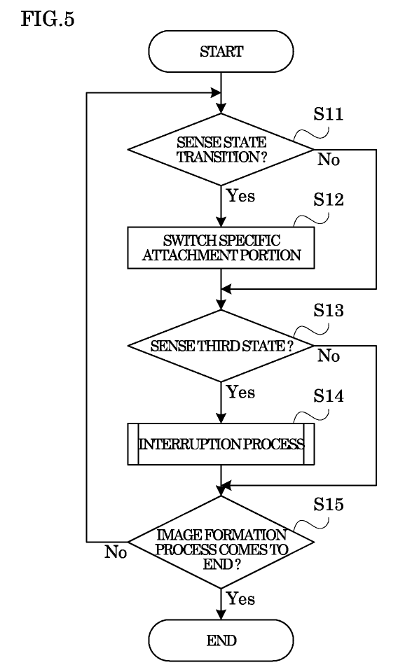

The following describes a setting method according to this disclosure along with examples of procedures of a specific attachment portion setting process that is executed by the control portion 8 in the image forming apparatus 10 with reference to FIG. 5. Here, steps S11, S12, ... denote the numbers of processing procedures (steps) that are executed by the control portion 8. Additionally, in a case where the image formation process is executed by the image forming apparatus 10, the specific attachment portion setting process is executed along with the image formation process.

Here, in a case where the amount of toner remaining in the developing device 43 corresponding to the developed color of black (Bk) is less than or equal to the third threshold while the image formation process is in execution, toner is supplied from the toner container 7 attached to the specific attachment portion to the developing device 43 in the image forming apparatus 10. This toner supply process is an example of a supply step according to this disclosure and is executed by the supply processing portion 85 of the control portion 8.

### Step S11

First, in step S11, the control portion 8 determines whether or not the state transition from the first state in which the amount of remaining toner exceeds the first threshold to the second state in which the amount of remaining toner is less than or equal to the first threshold is sensed for the toner container 7 attached to the specific attachment portion. The process of sensing the state transition is an example of a sensing step according to this disclosure and is executed by the first sensing processing portion 86 of the control portion 8.

Here, when the control portion 8 determines that the state transition is sensed (Yes in S11), the control portion 8 shifts the process to step S12. In contrast, if the state transition is not sensed (No in S11), the control portion 8 shifts the process to step S13.

### Step S12

In step S12, the control portion 8 switches the specific attachment portion. That is, in a case where the current specific attachment portion is the first attachment portion, the control portion 8 sets the second attachment portion as the specific attachment portion. In addition, in a case where the current specific attachment portion is the second attachment portion, the control portion 8 sets the first attachment portion as the specific attachment portion. The process of step S12 is an example of a setting step according to this disclosure and is executed by the first setting processing portion 87 of the control portion 8.

### Step S13

In step S13, the control portion 8 determines whether or not the third state in which the amount of toner remaining in the developing device 43 corresponding to the developed color of black (Bk) is less than or equal to the second threshold is sensed. A process of sensing the third state is executed by the second sensing processing portion 88 of the control portion 8.

Here, when the control portion 8 determines that the third state is sensed (Yes in S13), the control portion 8 shifts the process to step S14. In contrast, if the third state is not sensed (No in S13), the control portion 8 shifts the process to step S15.

### Step S14

In step S14, the control portion 8 executes an interruption process described below.

### Step S15

In step S15, the control portion 8 determines whether or not the image formation process comes to an end.

Here, when the control portion 8 determines that the image formation process comes to an end (Yes in S15), the control portion 8 brings the specific attachment portion setting process to an end. In contrast, if the image formation process does not come to an end (No in S15), the control portion 8 shifts the process to step S11.

### Interruption Process

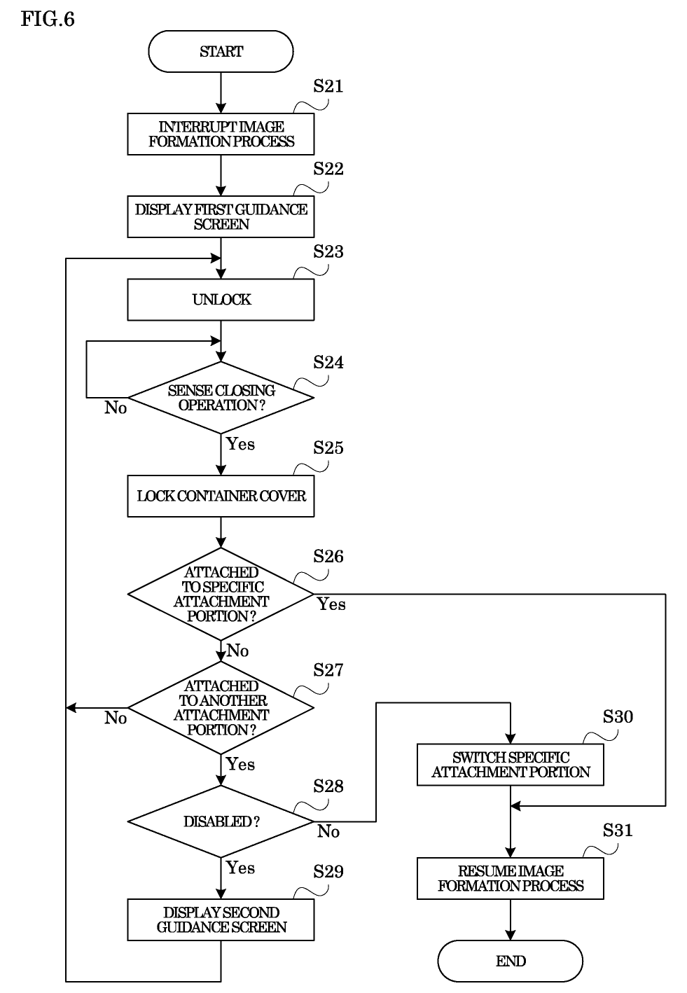

Next, examples of procedures of an interruption process that is executed in step S14 of the specific attachment portion setting process will be described with reference to FIG. 6.

### Step S21

First, in step S21, the control portion 8 interrupts the image formation process. The process of step S21 is executed by the interruption processing portion 89 of the control portion 8.

### Step S22

In step S22, the control portion 8 causes the display device 802 to display a first guidance screen defined in advance. The first guidance screen includes a message indicating that the image formation process is interrupted due to the lack of black toner. In addition, the first guidance screen includes a message that asks a user to attach the new toner container 7 to the specific attachment portion. In addition, the first guidance screen includes an image indicating the place of the specific attachment portion.

Here, the new toner container 7 is attached to only either of the pair of attachment portions 5 included in the one black attachment portion set 51 in the image forming apparatus 10 in some cases in a case where the one or two toner containers 7 attached to the one black attachment portion set 51 are replaced. In this case, a user attaches the new toner container 7 to the attachment portion 5 different from the specific attachment portion in some cases. That is, the user mistakes the attachment place of the new toner container 7 in some cases.

For this, in a case where a user mistakes the attachment place of the new toner container 7 and the function of the second setting processing portion 91 is set to be disabled, a report thereof is made for the user in the interruption process as described below. In addition, in a case where a user mistakes the attachment place of the new toner container 7 and the function of the second setting processing portion 91 is set to be enabled, the specific attachment portion is switched in the interruption process.

### Step S23

In step S23, the control portion 8 changes the state of each of the lock mechanisms 6 included in the one lock mechanism set 6x corresponding to the one black attachment portion set 51 from the lock state to the release state.

### Step S24

In step S24, the control portion 8 determines whether or not the closing operation on the cover member 1y (see FIG. 3) is sensed.

Here, when the control portion 8 determines that the closing operation is sensed (Yes in S24), the control portion 8 shifts the process to step S25. In contrast, if the closing operation is not sensed (No in S24), the control portion 8 waits for the closing operation to be sensed in step S24.

### Step S25

In step S25, the control portion 8 changes the state of each of the lock mechanisms 6 included in the one lock mechanism set 6x corresponding to the one black attachment portion set 51 from the release state to the lock state.

### Step S26

In step S26, the control portion 8 determines whether or not the toner container 7 is attached to the specific attachment portion. It is noted that the control portion 8 is capable of determining whether or not the specific attachment portion is in the attachment state by using the toner sensor 5s corresponding to the specific attachment portion as the attachment sensor.

Here, when the control portion 8 determines that the toner container 7 is attached to the specific attachment portion (Yes in S26), the control portion 8 shifts the process to step S31. In contrast, if the toner container 7 is not attached to the specific attachment portion (No in S26), the control portion 8 shifts the process to step S27.

### Step S27

In step S27, the control portion 8 determines whether or not the toner container 7 is attached to the attachment portion 5 different from the specific attachment portion.

Here, when the control portion 8 determines that the toner container 7 is attached to the attachment portion 5 different from the specific attachment portion (Yes in S27), the control portion 8 shifts the process to step S28. In contrast, if the toner container 7 is not attached to the attachment portion 5 different from the specific attachment portion (No in S27), the control portion 8 shifts the process to step S23.

### Step S28

In step S28, the control portion 8 determines whether or not the function of the second setting processing portion 91 is set to be disabled.

Here, when the control portion 8 determines that the function of the second setting processing portion 91 is set to be disabled (Yes in S28), the control portion 8 shifts the process to step S29. In contrast, if the function of the second setting processing portion 91 is not set to be disabled (No in S28), the control portion 8 shifts the process to step S30.

### Step S29

In step S29, the control portion 8 causes the display device 802 to display the second guidance screen including a message indicating that the toner container 7 is attached to the attachment portion 5 different from the specific attachment portion. The process of step S29 is executed by the report processing portion 90 of the control portion 8.

This allows a user to recognize that the attachment portion 5 to which the new toner container 7 is attached is not the specific attachment portion in a case where the user mistakes the attachment place of the new toner container 7.

### Step S30

In step S30, the control portion 8 sets the attachment portion 5 (the attachment portion 5 different from the specific attachment portion) to which the toner container 7 is attached as the specific attachment portion. The process of step S30 is executed by the second setting processing portion 91 of the control portion 8.

This makes it possible to prevent a user from having the burden of an operation of detaching the new toner container 7 from the current attachment portion 5 and attaching the new toner container 7 to the specific attachment portion in a case where the user mistakes the attachment place of the new toner container 7.

### Step S31

In step S31, the control portion 8 resumes the image formation process.

In this way, either of the pair of attachment portions 5 is set as the specific attachment portion in the image forming apparatus 10 on the basis of the setting status of the specific attachment portion up to the time of the sensing of the state transition in a case where the state transition is sensed. This makes it possible to prevent the pair of attachment portions 5 from being uneven in frequency of use.

In addition, in a case where the state transition is sensed, the attachment portion 5 different from the attachment portion 5 set as the specific attachment portion when the specific attachment portion is set immediately before is set as the specific attachment portion in the image forming apparatus 10. That is, the pair of attachment portions 5 alternately serves as the specific attachment portion. This makes it possible in a simple configuration to prevent the pair of attachment portions 5 from being uneven in frequency of use.

It is noted that the control portion 8 does not have to include the switch processing portion 92. In this case, a configuration is conceivable in which the function of the second setting processing portion 91 is kept enabled until the number of times the second setting processing portion 91 sets the specific attachment portion exceeds a reference number of times defined in advance and the function of the second setting processing portion 91 is disabled after the number of times the second setting processing portion 91 sets the specific attachment portion exceeds the reference number of times. This makes it possible to prevent the pair of attachment portions 5 from being more uneven in frequency of use.

In addition, the control portion 8 does not have to include both the switch processing portion 92 and the second setting processing portion 91. In this case, in a case where the toner container 7 is not attached to the specific attachment portion and the toner container 7 is attached to the attachment portion 5 different from the specific attachment portion when the closing operation on the cover member 1y is sensed after the image formation process is interrupted, it is favorable that the report processing portion 90 report that the toner container 7 is attached to the attachment portion 5 different from the specific attachment portion.

In addition, the one attachment portion set 5x may include the three or more attachment portions 5. In this case, it is favorable to store information indicating the setting status of the specific attachment portion from reference time defined in advance such as the time of the factory shipment or the system reset of the image forming apparatus 10 in the specific storage region of the non-volatile memory 84 instead of the specific attachment portion identifying information. For example, it is favorable to store the number of times each of the attachment portions 5 included in the one attachment portion set 5x is set as the specific attachment portion in the specific storage region. In addition, it is favorable that the first setting processing portion 87 set, as the specific attachment portion, any of the plurality of attachment portions 5 included in the one attachment portion set 5x that is set as the specific attachment portion the smallest number of times.

### SUPPLEMENTARY NOTES OF DISCLOSURE

The gist of the disclosure extracted from the embodiment described above will be supplementarily noted below. It is noted that the respective configurations and the respective processing functions described in the following supplementary notes can be sorted out and used in any combination.

### Supplementary Note 1

An image forming apparatus including:

an image forming portion configured to form an image using developer;

a plurality of attachment portions to which a plurality of developer storing portions configured to store the developers of a same color is attached;

a supply processing portion configured to supply the developer to the image forming portion from the developer storing portion attached to a specific attachment portion that is any of a plurality of the attachment portions set in advance;

a first sensing processing portion configured to sense state transition from a first state in which an amount of the developer remaining in the developer storing portion attached to the specific attachment portion exceeds a first threshold defined in advance to a second state in which the amount of the developer remaining in the developer storing portion is less than or equal to the first threshold; and

a first setting processing portion configured to set any of a plurality of the attachment portions as the specific attachment portion on the basis of a setting status of the specific attachment portion up to time of sensing of the state transition in a case where the state transition is sensed by the first sensing processing portion.

### Supplementary Note 2

The image forming apparatus according to Supplementary Note 1, in which

a number of the attachment portions is two, and

in the case where the state transition is sensed by the first sensing processing portion, the first setting processing portion sets, as the specific attachment portion, the attachment portion different from the attachment portion set as the specific attachment portion when the specific attachment portion is set immediately before.

### Supplementary Note 3

The image forming apparatus according to Supplementary Note 1 or 2, including:

a cover member configured to be opened and closed when the developer storing portion is replaced;

a second sensing processing portion configured to sense a third state in which the amount of the developer remaining in the image forming portion is less than or equal to a second threshold defined in advance;

an interruption processing portion configured to interrupt an image formation process of forming an image using the image forming portion in a case where the third state is sensed by the second sensing processing portion; and

a report processing portion configured to report that the developer storing portion is attached to the attachment portion different from the specific attachment portion in a case where the developer storing portion is not attached to the specific attachment portion and the developer storing portion is attached to the attachment portion different from the specific attachment portion when a closing operation on the cover member is sensed after the image formation process is interrupted.

### Supplementary Note 4

The image forming apparatus according to Supplementary Note 3, including:

a second setting processing portion configured to set any of the attachment portions to which the developer storing portion is attached as the specific attachment portion in the case where the developer storing portion is not attached to the specific attachment portion and the developer storing portion is attached to the attachment portion different from the specific attachment portion when the closing operation is sensed after the image formation process is interrupted; and

a switch processing portion configured to switch between enabling and disabling a function of the second setting processing portion in response to an operation of a user, in which

the report processing portion reports that the developer storing portion is attached to the attachment portion different from the specific attachment portion in a case where the developer storing portion is not attached to the specific attachment portion, the developer storing portion is attached to the attachment portion different from the specific attachment portion, and the function of the second setting processing portion is disabled when the closing operation on the cover member is sensed after the image formation process is interrupted.

### Supplementary Note 5

A setting method that is executed by an image forming apparatus including an image forming portion configured to form an image using developer, and a plurality of attachment portions to which a plurality of developer storing portions configured to store the developers of a same color is attached, the setting method including:

a supply step of supplying the developer to the image forming portion from the developer storing portion attached to a specific attachment portion that is any of a plurality of the attachment portions set in advance;

a sensing step of sensing state transition from a first state in which an amount of the developer remaining in the developer storing portion attached to the specific attachment portion exceeds a first threshold defined in advance to a second state in which the amount of the developer remaining in the developer storing portion is less than or equal to the first threshold; and

a setting step of setting any of a plurality of the attachment portions as the specific attachment portion on the basis of a setting status of the specific attachment portion up to time of sensing of the state transition in a case where the state transition is sensed through the sensing step.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an image forming portion configured to form an image using developer;
a plurality of attachment portions to which a plurality of developer storing portions configured to store the developers of a same color is attached;
a supply processing portion configured to supply the developer to the image forming portion from the developer storing portion attached to a specific attachment portion that is any of a plurality of the attachment portions set in advance;
a first sensing processing portion configured to sense state transition from a first state in which an amount of the developer remaining in the developer storing portion attached to the specific attachment portion exceeds a first threshold defined in advance to a second state in which the amount of the developer remaining in the developer storing portion is less than or equal to the first threshold; and
a first setting processing portion configured to set any of a plurality of the attachment portions as the specific attachment portion on a basis of a setting status of the specific attachment portion up to time of sensing of the state transition in a case where the state transition is sensed by the first sensing processing portion.

2. The image forming apparatus according to claim 1, wherein
a number of the attachment portions is two, and
in the case where the state transition is sensed by the first sensing processing portion, the first setting processing portion sets, as the specific attachment portion, the attachment portion different from the attachment portion set as the specific attachment portion when the specific attachment portion is set immediately before.

3. The image forming apparatus according to claim 1, comprising:
a cover member configured to be opened and closed when the developer storing portion is replaced;
a second sensing processing portion configured to sense a third state in which the amount of the developer remaining in the image forming portion is less than or equal to a second threshold defined in advance;
an interruption processing portion configured to interrupt an image formation process of forming an image using the image forming portion in a case where the third state is sensed by the second sensing processing portion; and
a report processing portion configured to report that the developer storing portion is attached to the attachment portion different from the specific attachment portion in a case where the developer storing portion is not attached to the specific attachment portion and the developer storing portion is attached to the attachment portion different from the specific attachment portion when a closing operation on the cover member is sensed after the image formation process is interrupted.

4. The image forming apparatus according to claim 3, comprising:
a second setting processing portion configured to set any of the attachment portions to which the developer storing portion is attached as the specific attachment portion in the case where the developer storing portion is not attached to the specific attachment portion and the developer storing portion is attached to the attachment portion different from the specific attachment portion when the closing operation is sensed after the image formation process is interrupted; and
a switch processing portion configured to switch between enabling and disabling a function of the second setting processing portion in response to an operation of a user, wherein
the report processing portion reports that the developer storing portion is attached to the attachment portion different from the specific attachment portion in a case where the developer storing portion is not attached to the specific attachment portion, the developer storing portion is attached to the attachment portion different from the specific attachment portion, and the function of the second setting processing portion is disabled when the closing operation on the cover member is sensed after the image formation process is interrupted.

5. A setting method that is executed by an image forming apparatus including an image forming portion configured to form an image using developer, and a plurality of attachment portions to which a plurality of developer storing portions configured to store the developers of a same color is attached, the setting method comprising:
a supply step of supplying the developer to the image forming portion from the developer storing portion attached to a specific attachment portion that is any of a plurality of the attachment portions set in advance;
a sensing step of sensing state transition from a first state in which an amount of the developer remaining in the developer storing portion attached to the specific attachment portion exceeds a first threshold defined in advance to a second state in which the amount of the developer remaining in the developer storing portion is less than or equal to the first threshold; and
a setting step of setting any of a plurality of the attachment portions as the specific attachment portion on a basis of a setting status of the specific attachment portion up to time of sensing of the state transition in a case where the state transition is sensed through the sensing step.
